(19) United States
(12) Patent Application Publication
(10) Pub. No.: US 2009/0260528 A1
(43) Pub. Date: Oct. 22, 2009

(54) CLEANING DEVICE AND METHOD FOR SILK-SCREEN PRINTING OF PLATE ELEMENTS FOR ELECTRONICS OR THE LIKE

(75) Inventor: Andrea Baccini, San Biagio di Callalta (TV) (IT)

Correspondence Address: HAMRE, SCHUMANN, MUELLER & LARSON, P.C., P.O. BOX 2902, MINNEAPOLIS, MN, 55402-0902, US

(73) Assignee: APPLIED MATERIALS BACCINI SPA CON SOCIO UNICO, San Biagio di Callalta (TV) (IT)

(21) Appl. No.: 12/257,486

(22) Filed: Oct. 24, 2008

(30) Foreign Application Priority Data
Oct. 24, 2007 (IT) UD2007A000194

(51) Int. Cl. B05C 17/08; B41F 35/00; B41M 1/12

(52) U.S. Cl. 101/126; 101/425; 101/129

(57) ABSTRACT

A cleaning device for cleaning a silk-screen printing station able to effect a silk-screen print, by means of a print paste, of impressions on silicon or alumina-based plate elements, such as of the type for electronics, or other types of plate for electronics, and comprising a net with incisions coherent with the impressions to be printed, through which the silk-screen print of the print paste is effected on the plate elements, comprises removal means able to be positioned below the net so as to selectively remove the excess print paste from the net. The removal means comprises at least a strip provided with at least an adhesive layer, the strip is associated with unwinding means so as to unwind it in a controlled manner, and with means able to take the adhesive layer into contact, selectively, with at least part of the lower surface of the net.

### FIELD OF THE INVENTION

The present invention concerns a cleaning device and method for the silk-screen printing of plate elements for electronics, or similar elements, in particular, but not only, silicon based and for photovoltaic cells.

### BACKGROUND OF THE INVENTION

It is known that in order to make impressions or conductor tracks on silicon-based wafers, in particular but not only for photovoltaic cells, the silk-screen printing technique is used, with suitable printing pastes.

Silk-screen printing provides to use brushes or blades by means of which the paste is spread, with a determinate pressure, on a suitable net, suitably incised according to the desired development of the impressions to be made. The pressure of the blades and their alternate movement along the surface of the net determines the passage of the conductor paste through the incisions and its subsequent deposit on the wafer below, thus achieving the impressions.

Due to a non-optimum distribution, partial drying out and/or anomalies in the functioning of the feed circuit or the movement of the blades, the paste tends to be distributed in excess in certain zones, or to form accumulations of paste which are reflected on the lower surface of the net, which gives a deterioration of the print quality.

It is therefore necessary to periodically clean the nets, usually mechanically by means of scraping devices, using a brush, knife or scraper proper, which act under the net, eliminating the accumulations of paste.

To assist this mechanical cleaning, and make it more effective, contrasting the drying out of the conductor paste, it is necessary to apply determinate solvent substances, usually volatile, onto the scraping device, before or during scraping.

The use of solvents has the main disadvantage that it causes an at least partial pollution of the conductor paste which is printed, and therefore a deterioration in the quality of the print, since the solvent can migrate from the net to the printing paste.

In fact, no matter how carefully the quantity of solvent applied is dosed, and even though devices to dry the solvent may be provided, a part of it in any case comes into contact with the paste used for the printing.

Furthermore, in order to distribute the solvent it is necessary to provide suitable solvent containers, pressurized distribution circuits and relative controls of the functioning parameters of the distribution line.

Purpose of the present invention is to achieve a cleaning device and perfect a cleaning method for silk-screen printing, in particular for cleaning excess or accumulated conductor paste from the net used in silk-screen printing, which will prevent pollution by the cleaning solvent of the conductor paste and which, at the same time, is effective and easy and economical to make.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a cleaning device according to the present invention is used for cleaning a silk-screen printing station able to effect a silk-screen print, by means of a printing paste, of impressions on plate elements, such as of the type for electronics, based on silicon or alumina or other types of plates for electronics, advantageously wafers, in particular but not only for photovoltaic cells. The printing station comprises a net bearing incisions coherent with the impressions to be printed, through which the silk-screen printing is made of the printing paste on the silicon elements. The cleaning device comprises removal means, able to be positioned under the net in order to selectively remove the excess printing paste on said net.

According to a characteristic feature of the present invention, the removal means comprises at least a strip provided with at least an adhesive layer, advantageously of the collagen type or similar; the strip is associated with means to unwind it in controlled manner and with means able to take the adhesive layer, selectively, into contact with at least part of the net, advantageously its lower surface. The excess printing paste remains adherent to the adhesive layer.

The method according to the present invention therefore provides to use the strip with the adhesive layer, in the manner and times established and/or pre-determined, to remove the excess printing paste from the net.

Thanks to the present invention, and to the use of the adhesive layer, which in itself is not pollutant either for the printing paste or for the atmosphere, to the great advantage of the workers, and which does not release vapors that pollute the printing paste and the plate elements for electronics, thus compromising the silk-screen printing, there is no pollution by the cleaning solvent of the printing paste and, at the same time, the net is cleaned effectively and easily.

The present invention, since it does not require pressurized distribution circuits, containers, pipes, controls and dosing of the cleaning solvent, also has very limited production costs.

The present invention allows an optimum management of the cleaning, which can be done without contaminating the printing zone, both because the adhesive does not migrate into the conductor paste and also because the net, before cleaning, can be advantageously translated from the printing zone to a cleaning zone where the cleaning device is provided.

A variant of the invention provides that the strip is able to be translated, by means of at least a translation member, underneath the net so as to determine the complete cleaning substantially of the whole lower surface of the net.

Advantageously, moreover, the device according to the invention is mounted on a slider able to be removed from the printing station. In this way, the maintenance of the cleaning device and the replacement of the adhesive strip can be done even during the working of the plate elements for electronics, without interrupting the production cycle.

The present invention, according to needs, provides to increase and improve the cleaning effect, by using several strips in series.

Alternatively, it is possible to re-use in sequence the same strip on different portions of the net.

A variant of the invention provides to use scraper elements in cooperation with the adhesive strip.

Advantageously, the functioning of the device according to the present invention is controlled and commanded by a suitable control unit, according to pre-determined and/or selectively settable cleaning cycles.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a schematic representation of a silk-screen printing station;

FIG. 2 is a schematic representation of a cleaning device according to the present invention used in a cleaning zone associated with the printing station in FIG. 1;

FIG. 3 is a schematic representation of a variant of the cleaning device according to the present invention;

FIG. 4 is a schematic representation of another variant of the cleaning device according to the present invention;

FIG. 5 is a schematic representation of another variant of the cleaning device according to the present invention;

FIG. 6 is a schematic representation of a loading, printing and control apparatus with which the printing station in FIG. 1 is associated;

FIG. 7 is a schematic representation of a variant of FIG. 6;

FIG. 8 is a variant of FIG. 2.

### DETAILED DESCRIPTION OF A PREFERENTIAL FORM OF EMBODIMENT

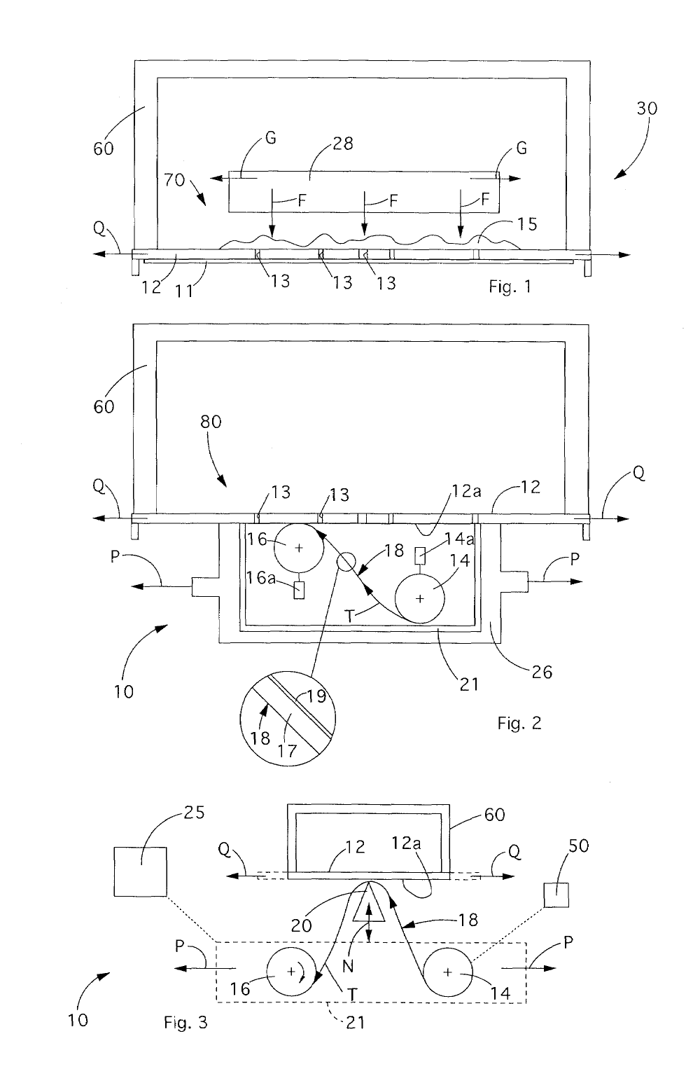

With reference to FIGS. 1 and 2, a cleaning device 10 according to the present invention is used in association with a silk-screen printing station 30 of silicon-based wafers 11, in particular for photovoltaic cells, for the silk-screen printing of relative conductor impressions or tracks, in a suitable cleaning zone 80 advantageously different from a printing zone 70 but in any case within the printing station 30.

The silk-screen printing station 30 is shown schematically in FIG. 1, where the proportions between the various elements are deliberately not respected, for greater ease of understanding.

The station 30 is provided, in traditional manner, with a printing blade 28, mobile as indicated by the arrows F and G in FIG. 1, which acts in the suitable printing zone 70. The blade 28 distributes and presses a conductor paste 15 against a net 12 bearing through incisions 13 coherent with the desired development of the impressions to be printed on the wafer 11 below.

The net 12 in this case is made mobile by a supporting head 60, to move it from the printing zone 70 to the cleaning zone 80.

The device 10 is schematically shown in FIG. 2 and comprises a strip 18 consisting of a first layer 17 of paper, plastic polymer or other similar material and able to be made in windable film, on which a second layer 19 is disposed, spread or applied, with a base of adhesive material, glue, collagen or other similar sticky material, said layers 17 and 19 being shown in the enlarged detail in FIG. 2.

The strip 18 is wound on a first feed roller 14, disposed under the net 12, which is made to rotate so as to unwind and feed the strip 18 towards the lower surface 12a of the net 12, so that the adhesive layer 19 goes into contact with the net 12.

The contact of the adhesive layer 19 with the net 12 causes the excess conductor paste 15 that has accumulated to adhere to the strip 18 and be removed. The excess paste 15 thus remains perfectly adherent to the strip 18, thus allowing the net 12 to be cleaned.

A winder roller 16 winds the strip 18 which has cleaned the net 12, where the paste 15 adheres to the layer 19.

The simultaneous action and the relative disposition of the rollers 14 and 16, the roller 16 above the roller 14 or vice versa, determines the unwinding of the strip 18 and also causes the strip 18 to be taken into contact with the lower surface 12a of the net 12.

According to one form of embodiment, the winder roller 16 may be driven and rotary, by means of its own motor 16a, whereas the feeder roller 14 may be idle or also driven, by means of its own motor 14a, at a speed coordinated with the speed of rotation of the winder roller 16, the latter pulling the strip 18 during the cleaning operation.

The use of the motor 14a of the first roller in coordination with the motor 16a of the second roller 16 can be of assistance for the necessary tensioning of the strip 18. In this case, the motor 16a operates at a higher number of revs than the motor 14a, continually or at least in a determinate interval of time, so as to make the roller 16 rotate faster than the roller 14 and cause a tensioning effect on the strip 18. Alternatively, the motor 14a can act as a brake with respect to the motor 16a, for example in counter-rotation, always to obtain the desired tensioning, or a proper brake can be provided, associated with the motor 14a.

Furthermore, to obtain the desired tensioning, it may also be provided to act on the relative mandrels of the rollers 14 and 16, pulling them towards the outside in opposite directions according to the desired degree of tension. This action on the mandrels can be exerted by the motors 14a and 16a themselves.

According to the invention, a translation member 26 is provided, for example actuated linearly, which allows to translate the rollers 14 and 16 and hence the strip, as indicated by the arrows P in FIG. 2, in order to move and clean the whole lower surface 12a of the net 12.

According to this solution, the net 12 is fixed and the device 10 moves under it during the cleaning cycle, thanks to the translation member 26.

Alternatively, the net 12 can be mobile, as indicated by the arrows Q and the dashes in FIG. 3, relative to the device 10, for example by means of the mobile head 60.

It is clear that the two solutions, that is, with the device 10 mobile or the net 12 mobile, although shown in dashes in the same figure, can be alternatives to each other or used simultaneously, according to needs.

It may also be provided that the net 12, during the cleaning operation, moves in an opposite direction, and therefore at a speed coordinated with the speed of feed of the strip 18, opposite the direction of rotation of the rollers 14 and 16, and then it can return to its operating position once the cleaning is completed, while the rollers 14 and 16, on the contrary, are stationary in the cleaning zone 80.

Alternatively, as shown in FIG. 8, a padding 23 is provided on which the strip 18 is disposed and moves.

The padding 23, mobile vertically according to the arrow D, acts from below, in cooperation with the strip 18. The padding 23 has sizes coordinated with those of the net 12 and thus acts over the whole potentially useable surface of the net 12, and in any case allows the cleaning action over the whole lower surface 12a of the net 12, without needing to translate the strip 18.

As shown in FIG. 2, and as can be applied also to the variants in FIGS. 3, 4 and 5 which will be described later, the device 10 can comprise a removable slider 21, on which the rollers 14 and 16 are mounted.

The slider 21 is selectively mobile with respect to the net 12, according to a pre-determined cleaning cycle. In particular, the slider 21 allows to remove the device 10 in order to check the state of the strip 18, also visually, in order to replace it or for other necessary maintenance operations. This allows any type of intervention on the device 10, even when the wafer 11 is being printed.

The slider 21 can be removed and the strip 18 can be changed advantageously automatically, according to predefined modes of intervention which will be dealt with hereafter in the description.

FIG. 3 shows a variant of the device 10 which provides a cleaner scraper 20, between the feed roller 14 and the winder roller 12, acting on the lower surface 12a of the net 12.

The strip 18 is fed so as to be interposed between the cleaner scraper 20 and the lower surface 12a of the net 12, being pressed by the scraper against the net 12. In this variant the adhesive action of the layer 19 is combined with the action of mechanical removal of the scraper 20.

In this case, the rollers 14 and 16 are at the same height and unwind the strip 18.

The scraper 20 can be mobile vertically, as indicated by the arrow N, to selectively take the strip 18 into contact with the net and to allow the necessary operations to replace the strip 18 and to maintain the whole.

The cleaning device 10, according to an advantageous variant, can comprise a control unit 25 of the electronic/data processing type, which commands the functioning of everything according to one or more predetermined cleaning cycles loaded in the memory and coordinated with the functioning of the printing station 30.

According to a variant, the functioning of the device 10 is controlled by the unit 25 according to a predefined number of printing cycles, after which it is necessary to clean the net 12.

In another variant, the unit 25 determines the start of a cleaning cycle when a suitable control TV camera 40, shown for convenience in FIGS. 6 and 7 only, detects an anomaly in the result of the printing and signals a corresponding need for cleaning.

It is also provided that the unit 25 can determine the start of the cleaning cycle following a prolonged machine downtime.

Finally, the unit 25 can also receive external inputs, for example from a specialized operator who, according to certain evaluations, sets the start of a cleaning cycle manually.

According to one form of embodiment, the control unit 25 also controls the cleaning strip 18 and the removal of the whole by means of the slider 21.

The unit 25 verifies when the strip 18 of the roller 14 is about to finish and supplies a suitable alarm signal to the operator, thanks to a control signal received from a sensor associated with the roller 14, schematically indicated in FIG. 3 by the block 50 and of which we shall describe briefly some possible forms of embodiment hereafter.

In one solution, the unit 25 advantageously uses a micrometric sensor which measures the remaining thickness of the strip 18.

Another solution provides to use an encoder sensor interfaced with the unit 25 that calculates the number of rotations performed by the rollers 14 and 16 and associates it with the actual consumption of paper, signaling that it is about to finish.

Another solution provides to use an electric current probe or sensor, which measures the current absorption of the motor that drives one or the other of the rollers 14, 16 to rotate. A consistent decrease in the strip 18 corresponds to a lesser weight of the relative roller 14 or 16 and hence a reduced electric power absorbed by the motor, which is detected by the current probe. All this is translated into a signal to the unit 25 which indicates that the strip 18 is finished.

Another advantageous use of the unit 25 is as follows. As we said, the net 12 is mobile by means of the supporting head 60 and, before cleaning, when necessary, the unit 25 commands the movement of the net 12 from the printing zone 70 to the cleaning zone 80 and the subsequent start of cleaning. This is to prevent the contamination by impurities of the printing zone. Only when the net 12 has been distanced from the printing zone and is in the cleaning zone 80 does the unit 25 give consent to the start of the cleaning cycle.

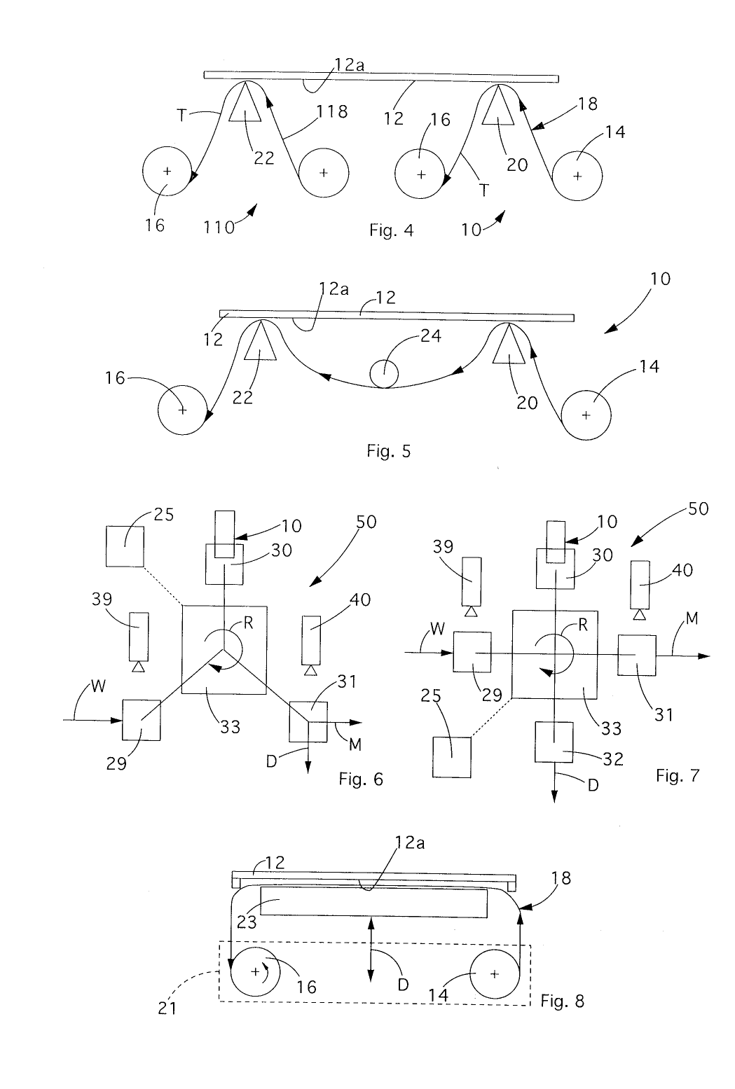

FIG. 4 shows a variant that provides two cleaning devices 10, 110 in series, but there could also be more, according to needs, of which a first device 10, equipped with its own cleaning strip 18 and a first scraper 20, effects a rough cleaning of the net 12 and a second device 110, equipped with its own cleaning strip 18 and a second scraper 22, effects a finishing cleaning of the net 12.

According to needs, the rollers 14 and 16 of the two devices 10 and 110 can be made to rotate in opposing rotation or in phase.

Furthermore, the rollers 14 and 16 of the two devices 10 and 110 can be made to rotate alternately or concomitantly.

In this case of FIG. 4 too, both the first scraper 20 and the second scraper 22 can be mobile vertically, so as to selectively take the strip 18, 118 towards the net 12.

In this case, the adhesive properties of the relative adhesive layers 19 of the strips 18 and 118 of the first and second device 10 and 110 can be chosen differently, to obtain a gradual action to remove the excess conductor paste 15, just as the action and the pressure with which the scrapers 20 and 22 act on the net 12 can be graduated.

The variant in FIG. 5 provides to use a single cleaning strip 18, fed in series to two successive scrapers 20 and 22, with the interposition of an idle guide roller 24. The first scraper 20 and the strip 18 just fed by the roller 14 effect a rough cleaning of the net 12 while the second scraper 22 and the strip 18 which has already made a first cleaning pass of the net 12 provide a finishing cleaning.

The device 10 is advantageously integrated into a silk-screen printing station 30 which is part of a loading, printing and control apparatus 50 for the silk-screen printing of silicon-based wafers 11, controlled and commanded by a control unit, which can also be the aforesaid control unit 25 (FIG. 6).

The apparatus 50 comprises a first loading station 29, advantageously automated, where the wafers 11 to be printed are loaded, as indicated by the arrow W, which are normally transported by means of a central turret 33, rotating in the direction of the arrow R, to the subsequent printing station 30.

At the first station 29 there is a first control of the quality of the wafers 11 by a TV camera 39. According to the images filmed by the TV camera 39, the unit 25 commands the rotary turret 33, determining the transport of the wafers 11 to the subsequent printing station 30.

If the control by the TV camera 39 detects defects in the wafers 11, the silk-screen printing is inhibited and the turret 33 takes the wafers directly to a subsequent third station 31 where, by means of diversion means, mobile blades or other discard devices, the defective wafers 11 are discarded, as indicated by the arrow D.

If the control by the TV camera 39 does not find any defects, consent is given for the printing operation.

Once printing has been done, the rotary turret 33 transports the silk-screen printed wafers 11 to the third station 31, where the quality of the printing is controlled by means of the TV camera 40. The signal detected by the TV camera 40 is used by the unit 25 both to determine the cleaning of the net 12 and to replace the strip 18 and also, according to determinate quality standards, to supply consent to the continuation of the wafers 11 to subsequent working.

If there are no printing defects, the wafer 11 continues, as indicated by the arrow M, to subsequent working.

If the TV camera 40 detects printing defects in the wafers 11, these are discarded as indicated by the arrow D, as described above for the wafers 11 which were already defective when controlled at station 29.

FIG. 7 shows a variant of the apparatus 50, in which there is a fourth station 32, after the third control station 31. In this case, the wafers 11 found defective when controlled at station 29, or the wafers 11 with printing defects detected at station 31, are discarded in said fourth station 32, as indicated by the arrow D. Therefore, in the third station 31 the only operations performed are the control of the printing, by means of the TV camera 40, and the sending of the wafers 11 which have no defects in general.

It is clear that modifications and/or additions of parts may be made to the cleaning device 10 and cleaning method for the silk-screen printing of plate elements for electronics as described heretofore, without departing from the field and scope of the present invention.

It is also clear that, although the present invention has been described with reference to specific examples, a person of skill in the art shall certainly be able to achieve many other equivalent forms of cleaning device 10 and cleaning method for the silk-screen printing of plate elements for electronics, or similar elements, having the characteristics as set forth in the claims and hence all coming within the field of protection defined thereby.

1. A cleaning device for cleaning a silk-screen printing station able to effect a silk-screen print, by means of a print paste, of impressions on silicon or alumina-based plate elements, such as of the type for electronics, or other types of plate for electronics, and comprising a net with incisions coherent with the impressions to be printed, through which the silk-screen print of the print paste is effected on said plate elements, said cleaning device comprising removal means able to be positioned below the net so as to selectively remove the excess print paste from the net, wherein the removal means comprises at least a strip provided with at least an adhesive layer, wherein the strip is associated with unwinding means so as to unwind the strip in a controlled manner, and with means able to take the adhesive layer into contact, selectively, with at least part of the lower surface of the net.

2. A cleaning device as in claim 1, wherein the strip is also able to be translated, by means of at least a translation member, under the net so as to determine the complete cleaning substantially of the whole lower surface of the net.

3. A cleaning device as in claim 1, wherein the strip has a fixed position with respect to the net, during the cleaning operation, padding means being provided in cooperation with the strip in order to determine the cleaning action by the strip substantially of the whole lower surface of the net.

4. A cleaning device as in claim 1, wherein the unwinding means comprises at least a first feed roller that carries the strip, wound up, to be taken into contact with the net, and at least a second winder roller, able to wind the strip after the latter has cleaned the net.

5. A cleaning device as in claim 4, wherein the second roller is driven in rotation by means of a motor, in order to pull and wind the strip.

6. A cleaning device as in claim 5, wherein the second roller also determines the rotation of the first roller.

7. A cleaning device as in claim 5, wherein the motor of the second roller is able to assist the tensioning of the strip.

8. A cleaning as in claim 4, wherein the first roller is driven in rotation by means of a motor.

9. A cleaning device as in claim 8, wherein the motor of the first roller is able to assist the tensioning of the strip.

10. A cleaning device as in claim 4, wherein the first roller is driven independently with respect to the second roller.

11. A cleaning device as in claim 4, comprising at least a slider, on which both the first roller and the second roller are mounted.

12. A cleaning device as in claim 11, wherein the slider can be removed from the silk-screen printing station.

13. A cleaning device as in claim 11, wherein the slider and the net are able to be moved relatively to each other, in a manner coherent with the cleaning action performed by the strip.

14. A cleaning device as in claim 13, wherein the slider is selectively mobile and the net is fixed.

15. A cleaning device as in claim 13, wherein the slider is fixed and the net is selectively mobile.

16. A cleaning device as in claim 1, wherein the means to take the strip into contact with the lower surface of the net consists of the unwinding means.

17. A cleaning device as in claim 1, wherein the means to take the strip into contact with the lower surface of the net comprises at least a scraper element able to cooperate with the strip in order to clean the net.

18. A cleaning device as in claim 17, wherein, in normal operating use, the strip is interposed between the net and the scraper element.

19. A cleaning device as in claim 17, wherein the scraper element is able to be moved so as to contact, directly or indirectly, the net.

20. A cleaning device as in claim 1, comprising two strips in sequence, of which a first strip effects a rough cleaning of the net and a second strip effects a finishing cleaning of the net.

21. A cleaning device as in claim 1, wherein, during normal use, the strip has at least two portions, simultaneously active in cleaning, of which a first portion is provided in order to effect a rough cleaning of the net and a second portion is provided in order to effect a finishing cleaning of the net.

22. A cleaning device as in claim 1, comprising a control unit able to control and command the strip according to one or more selectable cleaning cycles.

23. A cleaning device as in claim 22, comprising sensor means able to detect the wear of the strip, the control unit being able to determine the need to replace and/or maintain the strip according to an indicative control signal received from said sensor means.

24. A cleaning device as in claim 1, comprising at least a video acquisition device able to control the print quality of the plate elements for electronics subjected to silk-screen printing.

25. A cleaning device as in claim 22, wherein the control unit is able to determine the need to start a cleaning cycle of the net according to an indicative control signal received from said video acquisition device.

26. A cleaning device as in claim 1, comprising a movement member able to selectively move the net between a printing zone and a cleaning zone, in correspondence with which to start cleaning by means of the strip.

27. A silk-screen printing station able to effect a silk-screen print, by means of a print paste, of impressions on silicon or alumina-based plate elements, such as of the type for electronics, or other types of plate for electronics, and comprising a net with incisions coherent with the impressions to be printed, through which the silk-screen print of the print paste is effected on said plate elements, said second station comprising a cleaning device that has removal means able to be positioned below the net so as to selectively remove the excess print paste from the net, wherein the removal means comprises at least a strip provided with at least an adhesive layer, wherein the strip is associated with unwinding means so as to unwind the strip in a controlled manner, and with means able to take the adhesive layer into contact, selectively, with at least part of the lower surface of the net.

28. A printing station as in claim 27, wherein the strip is also able to be translated under the net so as to determine the complete cleaning substantially of the whole lower surface of the net.

29. An apparatus for loading, silk-screen printing and control of silicon or alumina-based plate elements, such as of the type for electronics, or other types of plate for electronics, comprising a first station to load the plate elements, a second station to effect a silk-screen print by means of a print paste, of impressions on the plate elements and comprising a net with incisions coherent with the impressions to be printed, through which the silk-screen print of the print paste is effected on the plate elements, and at least a third station to control the plate elements for electronics subjected to silk-screen printing, automated movement means being provided to move the plate elements between the first station, the second station and the third station, wherein the second station comprises a cleaning device that comprises removal means, able to be positioned below the net so as to selectively remove the excess print paste from the net, wherein the removal means comprises at least a strip provided with at least an adhesive layer, wherein the strip is associated with unwinding means so as to unwind the strip in a controlled manner, and with means able to take the adhesive layer into contact, selectively, with at least part of the lower surface of the net.

30. A method for cleaning a silk-screen printing station able to effect a silk-screen print, by means of a print paste, of impressions on silicon or alumina-based plate elements, such as of the type for electronics, or other types of plate for electronics, and comprising a net with incisions coherent with the impressions to be printed, through which the silk-screen print of the print paste is effected on the plate elements, comprising a step of removing the excess print paste from the net, wherein the removal step provides to use at least a strip provided with at least an adhesive layer, wherein the strip is able to be unwound and to take the adhesive layer selectively into contact with at least part of the lower surface of the net, the excess print paste remaining adherent to said adhesive layer.

31. A method as in claim 30, wherein during the removal step the strip is translated below the net so as to effect cleaning substantially over the whole lower surface of the net.

32. A method as in claim 30, providing to use two strips in sequence, of which a first strip effects a rough cleaning of the net and a second strip effects a finishing cleaning of the net.

33. A method as in claim 30, providing to use the strip at least twice consecutively, of which a first use effects a rough cleaning of the net and a second use effects a finishing cleaning of the net.

34. A method as in claim 30, comprising a preliminary step of moving the net, by means of a movement member, from a printing zone to a cleaning zone.
